(19) United States
(12) Patent Application Publication
(10) Pub. No.: US 2026/0196591 A1
(43) Pub. Date: Jul. 9, 2026

(54) SYSTEMS, DEVICES, AND METHODS FOR BATTERY MODULE COOLING

(71) Applicant: TAE Technologies, Inc., Foothill Ranch, CA (US)

(72) Inventors: Andrew HUBBLE, Birmingham West Midlands (GB); Robert A. MITCHELL, Birmingham West Midlands (GB); Brian G. COOPER, Birmingham West Midlands (GB)

(21) Appl. No.: 19/131,770

(22) PCT Filed: Nov. 20, 2023
(86) PCT No.: PCT/US2023/080597

§ 371 Date: May 21, 2025

Related U.S. Application Data
(60) Provisional application No. 63/427,003, filed on Nov. 21, 2022.
(60) Provisional application No. 63/499,667, filed on May 2, 2023.
(60) Provisional application No. 63/506,724, filed on Jun. 7, 2023.

(51) Int. Cl. H01M 10/613; H01M 10/625; H01M 10/6556; H01M 10/6568; H01M 50/509; H01M 50/627; H01M 50/682

(52) U.S. Cl. CPC H01M 10/613; H01M 10/625; H01M 10/6556; H01M 10/6568; H01M 50/509; H01M 50/627; H01M 50/682

(57) ABSTRACT

Example embodiments of systems, devices, and methods are provided herein for a cooling fluid exchange for use with a battery module that houses one or more battery modules. The exchange includes a supply conduit structure having a first supply egress residing between a first supply end portion and a second supply end portion. The supply conduit structure is configured to receive a cooling fluid at the first supply ingress and direct the cooling fluid out of the supply conduit structure through the first supply egress. The exchange also includes a return conduit structure having a first return ingress residing between the first return end portion and the second return end portion. The return conduit structure is configured to receive the cooling fluid at the first return ingress and direct the cooling fluid to the first return egress.

### CROSS-REFERENCE TO RELATED APPLICATIONS

This application claims the benefit of U.S. Provisional Application No. 63/427,003, filed Nov. 21, 2022, U.S. Provisional Application No. 63/499,667, filed May 2, 2023, and U.S. Provisional Application No. 63/506,724, filed Jun. 7, 2023, all of which are incorporated by reference here in in their entireties and for all purposes.

### FIELD

The subject matter described herein relates generally to systems, devices, and methods for battery modules and, more particularly, to cooling methods and equipment for battery modules.

### BACKGROUND

Power cells are energy storage devices that are used in a variety of electronic applications, including consumer electronic applications, electric vehicle applications, military applications, and aerospace applications. The performance of power cells is dependent, in part, on the temperature of the power cells. As the temperatures of power cells increase, their efficiency often decreases. Moreover, if the temperature of a power cell exceeds a maximum rated temperature, the power cell may fail. Such failures may also be catastrophic. Thus, effectively cooling power cells results in power cells operating more efficiently and safely than when operating at higher temperatures, and can prevent the cells from failing. Methods and equipment for cooling power cells are sought.

For these and other reasons, needs exist for improved systems, devices, and methods for modular energy systems that that use power cells.

### SUMMARY

Example embodiments of systems, devices, and methods are described for a power cell module cooling design that achieves highly effective immersion fluid cooling. As used herein, a power cell module refers to a housing that includes multiple power cells located within the housing. The power cells may be interconnected within the housing, e.g., grouped in series or in parallel, or combinations thereof. A power cell module is also referred to as a battery module. Battery modules may be grouped together in a battery pack that includes two or more battery modules.

In particular, a cooling fluid exchange is utilized within the module to achieve a highly parallel fluid flow over the power cells. The result is high cooling effectiveness and minimum temperature differences across an individual cell as well as between cells within a battery module. Additionally, a thermal propagation defense strategy is described that ensures a neighboring cell does not enter thermal runaway in the event of a power cell failure of a power cell. This strategy inhibits heat propagation that may occur when a power cell vents and forces cooling fluid from a battery module containing the batteries. In particular, the system refills the lost fluid caused by cell venting by utilizing reserved fluid housed in a connected refill tank.

The cooling fluid exchange enables a parallel cooling architecture in which groups of power cells that are separated by the cooling fluid exchange can be effectively cooled in parallel. The housing using the cooling fluid exchange can be positioned vertically or horizontally, so that the axes of the cells being cooled are either parallel or vertical with respect to a resting surface, without losing efficiency. This allows for additional design flexibility when positioning the battery module, e.g., such as positioning relative to a road surface in an electric vehicle.

Other systems, devices, methods, features and advantages of the subject matter described herein will be apparent to one with skill in the art upon examination of the following figures and detailed description. It is intended that all such additional systems, methods, features and advantages be included within this description, and be within the scope of the subject matter described herein. In no way should the features of the example embodiments be construed as limiting the appended claims, absent express recitation of those features in the claims.

### BRIEF DESCRIPTION OF FIGURES

The subject matter set forth herein, both as to its structure and operation, is illustrated in the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 is a block diagram of a modular energy system.

FIG. 2 is a perspective view of battery pack that is capable of receiving multiple battery modules.

FIG. 3 is an illustration of power cells interconnected by bus bars.

FIG. 4A is a perspective view of an interior of an example embodiment of a battery module with first and second sets of power cells that are separated by a cooling fluid exchange.

FIG. 4B is a perspective view of the example embodiment of a battery module illustrating the flow of coolant fluid.

FIG. 4C is a perspective view of an example embodiment of a cooling fluid exchange.

FIG. 4D is a first side view of the cooling fluid exchange.

FIG. 4E is a second side view of the cooling fluid exchange, wherein the second side is opposite the first side.

FIG. 4F is a first side view of another example embodiment of the cooling fluid exchange.

FIG. 4G is a first side view of yet another example embodiment of the cooling fluid exchange.

FIG. 4H is a first side view of yet another example embodiment of the cooling fluid exchange.

FIG. 4I is a cross section view of the cooling fluid exchange providing central support in a battery module.

FIG. 4J is a perspective view of cooling fluid flow within the battery assembly.

FIG. 4K is a cross section view of the cooling fluid exchange configured to provide cooling on only one side of a battery module.

FIG. 4L is a side view of another embodiment of a cooling fluid exchange.

FIG. 4M is a cross section view of a battery module with an alternative power cell arrangement.

FIG. 5 is a flow diagram of an example method of cooling battery cells.

FIG. 6A is a cross-section view of another embodiment of a battery module.

FIG. 6B is a first side view of a cooling fluid exchange used in the battery module of FIG. 6A.

FIG. 6C is a second side view of a cooling fluid exchange used in the battery module of FIG. 6A.

FIGS. 7A-7F are illustrations of various stages of coolant fluid levels in the battery assembly during filling and venting events.

### DETAILED DESCRIPTION

Before the present subject matter is described in detail, it is to be understood that this disclosure is not limited to the particular embodiments described, and as such may, of course, vary. The terminology used herein is for the purpose of describing particular embodiments only, and is not intended to be limiting, since the scope of the present disclosure will be limited only by the appended claims.

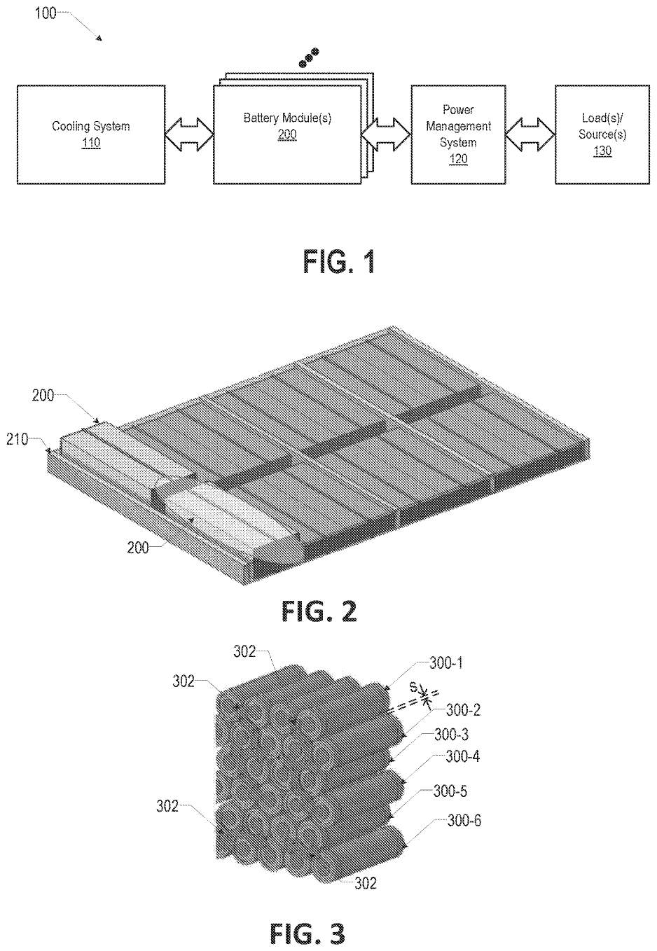

Before describing the example embodiments pertaining to modular energy systems that provide efficient battery module cooling as described herein, it is first useful to describe these underlying systems in greater detail. With reference to FIGS. 1 through 7F, the following sections describe various applications in which embodiments of the modular energy systems can be implemented, embodiments of control systems and devices for the modular energy systems, and particular embodiments of the modular energy system for cooling.

### Examples of Applications

Stationary applications are those in which the modular energy system is located in a fixed location during use, although it may be capable of being transported to alternative locations when not in use. The modular energy system resides in a static location while providing electrical energy for consumption by one or more other entities, or storing or buffering energy for later consumption. Examples of stationary applications in which modular energy systems incorporating the cooling fluid exchanges disclosed herein can be used include, but are not limited to: energy systems for use by or within one or more residential structures or locales, energy systems for use by or within one or more industrial structures or locales, energy systems for use by or within one or more commercial structures or locales, energy systems for use by or within one or more governmental structures or locales (including both military and non-military uses), energy systems for charging the mobile applications described below (e.g., a charge source or a charging station), and systems that convert solar power, wind, geothermal energy, fossil fuels, or nuclear reactions into electricity for storage. Stationary applications often supply loads such as grids and microgrids, motors, and data centers. A stationary energy system can be used in either a storage or non-storage role.

Mobile applications, sometimes referred to as traction applications, are generally ones where a modular energy system is located on or within an entity, and stores and provides electrical energy for conversion into motive force by a motor to move or assist in moving that entity. Examples of mobile entities with which the modular energy systems incorporating the cooling fluid exchanges disclosed herein can be used include, but are not limited to, electric and/or hybrid entities that move over or under land, over or under sea, above and out of contact with land or sea (e.g., flying or hovering in the air), or through outer space. Examples of mobile entities include, but are not limited to, vehicles, trains, trams, ships, vessels, aircraft, and spacecraft. Examples of mobile vehicles include, but are not limited to, those having only one wheel or track, those having only two-wheels or tracks, those having only three wheels or tracks, those having only four wheels or tracks, and those having five or more wheels or tracks. Examples of mobile entities include, but are not limited to, a car, a bus, a truck, a motorcycle, a scooter, a bicycle, an industrial vehicle, a mining vehicle, a flying vehicle (e.g., a plane, a helicopter, a drone, etc.), a maritime vessel (e.g., commercial shipping vessels, ships, yachts, boats or other watercraft), a submarine, a locomotive or rail-based vehicle (e.g., a train, a tram, etc.), a military vehicle, a spacecraft, and a satellite.

In describing embodiments herein, reference may be made to a particular stationary application (e.g., grid, micro-grid, data centers, cloud computing environments) or mobile application (e.g., an electric car). Such references are made for ease of explanation and do not mean that a particular embodiment is limited for use to only that particular mobile or stationary application. Embodiments of systems providing power to a motor can be used in both mobile and stationary applications. While certain configurations may be more suitable to some applications over others, all example embodiments disclosed herein are capable of use in both mobile and stationary applications unless otherwise noted.

### Second Life Energy Source Examples

Power cells described herein can be used in systems 100 described herein in both first life and second life applications. A first life of power cell is an original application in which power cell is used. For example, the first life application is the first implementation in which power cells are put to use by the first customer of power cells after their original manufacture (and not refurbishment). The user of power cells in their first life will typically have received power cells from the manufacturer, distributor, or original equipment manufacturer (OEM). For battery power cells used in a first life application, the battery will typically have the same electrochemistry (e.g., will have the same variant of lithium ion electrochemistry (e.g., LFP, NMC)) and will have the same nominal voltage and will have a capacity variation across the pack or system that is minimal (e.g., 5% or less). Use of an energy storage system with batteries in their first life application will result in batteries having a longer lifespan in that first life application, and upon removal from that first life application, the batteries will be more similar in terms of capacity degradation than batteries from a first life application not using the energy storage system.

As used herein, a “second life” application refers to any application or implementation after the first life application (e.g., a second implementation, third implementation, fourth implementation, etc.) of power cell. A second life energy source refers to any energy source (e.g., battery or HED capacitor) implemented in that source's second life application.

An example of a first life application for batteries is within an energy storage system for an EV. Then, at the end of that life (e.g., after 100,000 miles of driving, or after degradation of the batteries within that battery pack by a threshold amount), the batteries can be removed from the battery pack, optionally subjected to refurbishing and testing, and then implemented in a second life application that can be, e.g., used within a stationary energy storage system (e.g., residential, commercial, or industrial energy buffering, EV charging station energy buffering, renewable source (e.g., wind, solar, hydroelectric), energy buffering, and the like) or another mobile energy storage system (e.g., battery pack for an electric car, bus, train, or truck). Similarly, the first life application can be a first stationary application and the second life application can be a stationary or mobile application.

For the second life application, power cells can be selected and/or utilized by a system to minimize (or at least reduce) any differences in initial capacity and nominal voltage. For example, power cells having a capacity difference of 5% or more can be included within a system and operated to provide energy for a load. In another example, an operator or automated system can select power cells for the system that have a capacity difference within a threshold amount, e.g., to reduce the initial capacity differences between power cells.

Whether used in either a first life application or a second life application, the power cells still require adequate cooling. The systems and methods described below can provide such cooling for both first life applications and second life applications.

### Power Cell Cooling System Examples

FIG. 1 is a block diagram of a modular energy system 100. The modular energy system 100 includes a cooling system 110, a power management system 120, loads/sources 130, and one or more battery modules 200.

The battery modules 200 are described in more detail with reference to FIGS. 2-6C. Each battery module includes a cooling fluid exchange that, when fluidly coupled to the cooling system 110, enables the flow of cooling fluid through the battery module 200 to provide cooling of power cells housed within the battery module 200.

The cooling system 110 cools the battery modules 200. In an example embodiment, the cooling system 110 utilizes cooling fluid that is circulated through the battery modules 200 by use of the cooling fluid exchange. The cooling system 110 includes temperature sensors, one or more pumps, and control electronics to manage the flow of cooling fluid to provide cooling of the battery modules 200. Any appropriate cooling system that can manage cooling fluid flow can be utilized in the system 100.

The power management system 120 includes electronics and control systems that provide power management functions for the loads/sources 130 and the battery modules 200. The particular power management functions will depend on the application in which the system 100 is utilized. For example, in an electric vehicle application, the power management system 120 may provide a first set of power management functions, while in a hybrid electric vehicle application, the power management system 120 may provide a second set of power management functions that are different from the first set of power management functions. For example, a power management system on a hybrid electric vehicle may tolerate lower state of charge usage for a battery module than for an electric vehicle, as the hybrid electric vehicle has more opportunities to charge when under the power of the internal combustion engine. Accordingly, a load balancing algorithm to reduce variance of state of charge in individual power cells in an electric vehicle may be stricter than a load balancing algorithm to reduce variance of state of charge in a hybrid electric vehicle.

As described above, the system 100 may use multiple battery modules, depending on the particular application. FIG. 2 is a perspective view of battery pack 210 that is capable of receiving multiple battery modules 200. The battery pack 210 may be used in a battery electric vehicle (BEV) application, for example. In FIG. 2, the pack 210 has sixteen battery modules 200 attached, but additional battery modules can also be attached, depending on the power requirements required for the BEV application.

FIG. 3 is an illustration of power cells 300 interconnected by bus bars 302. The power cells 300 may be, for example, lithium-ion batteries, but other power cell types can also be used. The bus bars 302 may be constructed from any suitable conductive material commonly used for bus bar fabrication. The power cells 300 can be charged by a power converter such as a DC-DC converter that receives power from a fuel cell or from a grid, or from some other charging source or sources.

Any two or more power cells 300 can form a group of power cells. The power cells 300 in a group need not be electrically connected to each other. However, the power cells 300 are usually connected to each other when forming a group. For example, in FIG. 3, the power cells 300 are connected by a particular bus bar configuration to form a group of power cells.

The particular type of power cells 300 and configuration of bus bars 302 are selected based on the desired specification of kWh energy, peak kW discharge, peak kW power, kW continuous usage, and any other specifications. Various configurations can be used, and power cell groups are typically connected in series, and then configured in parallel loops. For example, 30P12S configuration means that twelve cells 300 are connected in series, and then arranged in 30 parallel loops. Other configurations, such as 4P192S, 30P192S, and 24P200S, can also be used, depending on the desired application and the particular type of power cell 300 available.

In FIG. 3, the power cells 300 are cylindrical in shape and arranged in a staggered manner of six cells 300-1 . . . 300-6, and with space S (not to scale) between each cell 300 to facilitate the flow of coolant between the cells, as will be described in more detail below. Power cells 300 of other geometric shapes can also be used, however, including rectangular shaped cells, triangular shaped cells, etc. More broadly, any power cell 300 that is either polygonal shaped or elliptically shaped can be used. In addition, power cells 300 can also have irregular shapes, e.g., pouch cells.

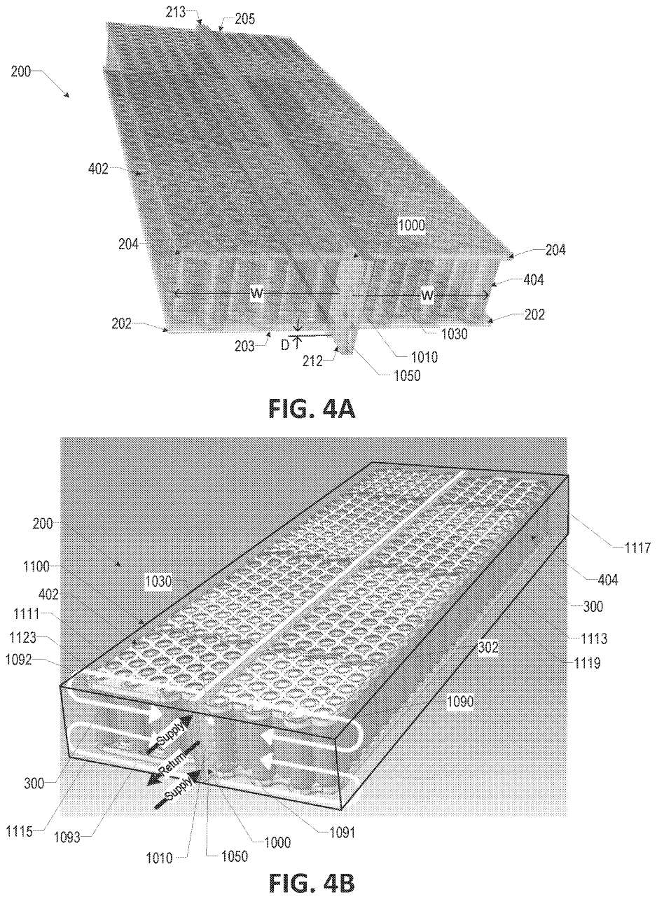

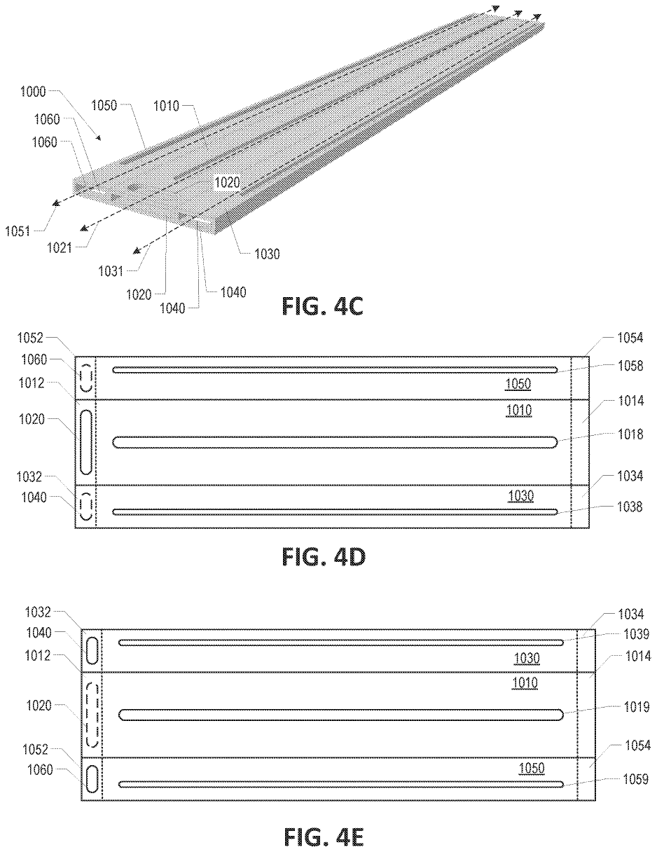

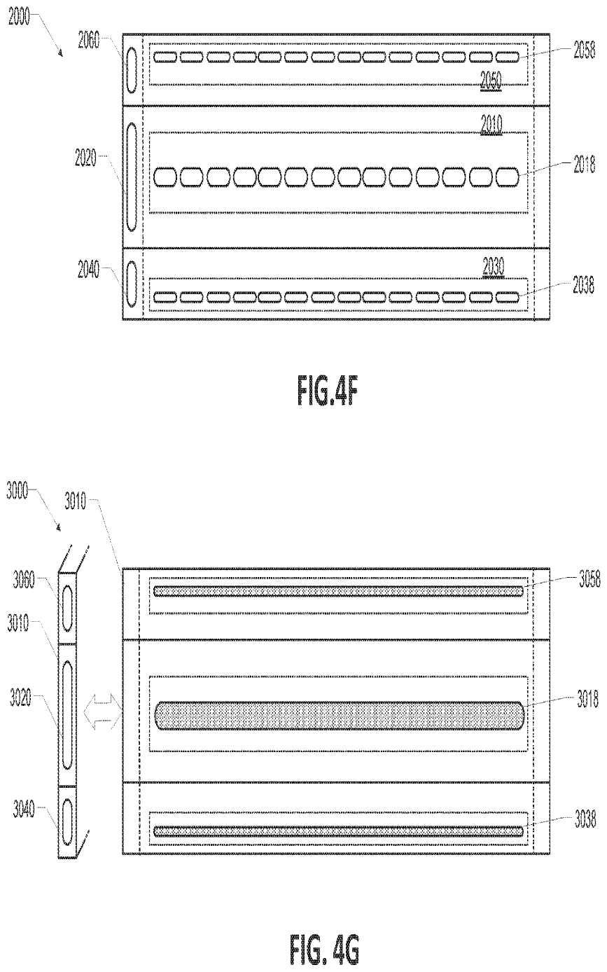

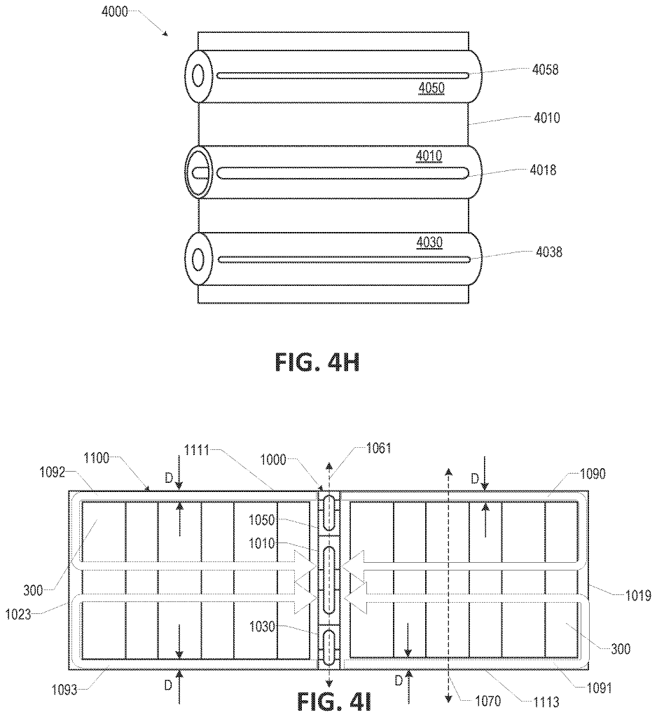

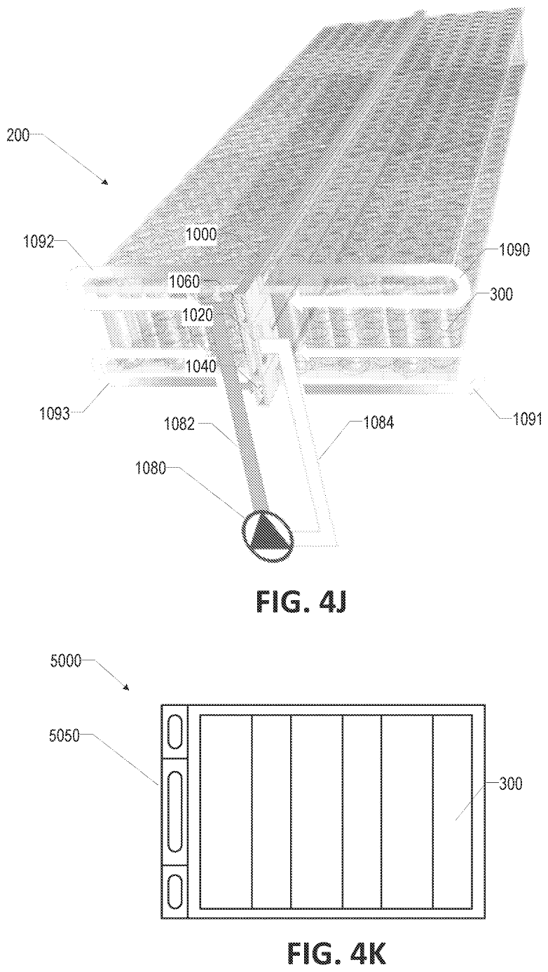

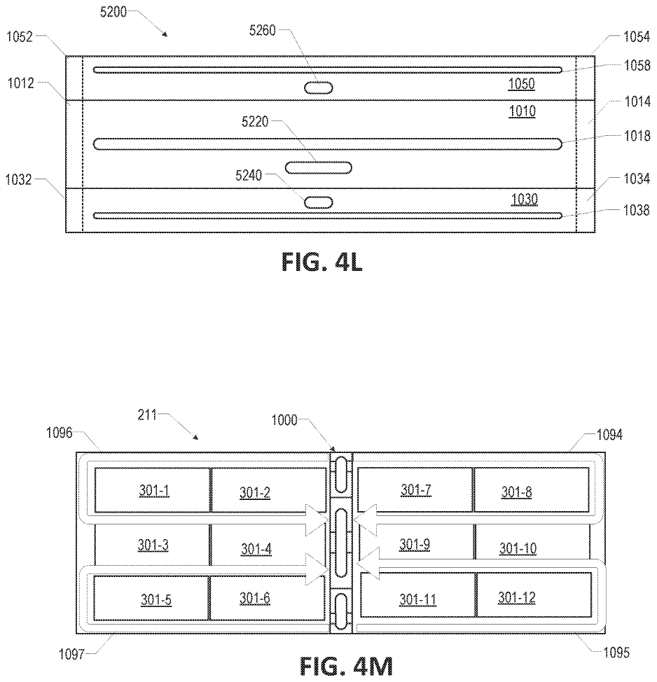

Example embodiments of cooling systems for battery modules 200 will now be described with reference to FIGS. 4A-6C. These embodiments can be implemented within the system 100 described with reference to FIG. 1.

A first example embodiment of the battery module 200 is described with reference to FIGS. 4A and 4B. FIG. 4A is a perspective view of an interior of the example embodiment of the battery module 200 with first and second sets 402 and 404 of power cells 300, each of one or more groups, that are separated by a cooling fluid exchange 1000. FIG. 4B is a perspective view of a battery module 200 illustrating the flow of coolant. The battery module 200 can be part of an electrically powered vehicle (not shown) or a hybrid vehicle, or part of a system used in a stationary application.

In FIG. 4A, the power cells 300 are shown in phantom. The cells 300 are divided into two separate sets 402 and 404, with one set on either side of the cooling fluid exchange 1000. As shown in FIG. 4A, the first set 402 is the set of power cells 300 to the left of the cooling fluid exchange 1000, and the second set 404 is the set of power cells 300 to the right of the cooling fluid exchange 1000. Each set 402 and 404 of power cells is supported by bottom braces 202 and top braces 204. In this example embodiment, these braces 202 and 204 are secured to the cooling fluid exchange 1000 and, optionally, to other parts of the housing 1100 of the battery module 200 (the housing is not shown in FIG. 4A, but is depicted in outline form in FIG. 4B).

As illustrated in FIG. 4A, brace 202 is positioned so that the bottom side 203 of brace 202, and thus the bottom sides of the power cells 300, are spaced above the bottom side 212 of the cooling fluid exchange 1000 by a distance D (not to scale).

The top side 205 of the brace 204 is spaced below from the top side of the 213 of the cooling fluid exchange 1000 by a similar distance D (not shown to avoid congestion in the drawing), and thus the top sides of the power cells 300 are spaced below the top side 213 of the of the cooling fluid exchange 1000 by the distance D. This distance D allows for the flow of coolant along the top and bottom ends of the power cells, as will be described in more detail below.

A variety of gap distances D can be used, depending on a desired flow rate, a desired cooling capacity, and/or a desired flow velocity. For example, in some embodiments, the gap distance D is selected to manage flow velocity across the power cells for a desired cooling capacity. In general, the distance D is selected so the amount of fluid that can flow through the gaps can accommodate the thermal transfer required to keep the power cells cooled to a specified temperature, e.g., a maximum rated temperature for a particular mode of operation. Thus, as the stack width W of the number of power cells 300 being cooled increases, so too will the distance D for a given flow velocity within the gap.

With reference to FIG. 3, the space S between individual cells is selected so that the resulting backpressure generated during fluid flow is independent of the influence of orientation, gravity, or expected g-forces in mobile applications. The distance S may also take into account cell manufacturing tolerances and positional tolerances.

More generally, the gap distances and flow velocity vary based on the desired velocity to generate high heat transfer coefficients versus pressure drop that causes parasitic losses and the ability to control the flow passage width for given manufacturing tolerances.

The entire structure of FIG. 4A is placed within an inner volume of a housing 1100, as shown in the housing outline of FIG. 4B, to form the battery module 200. The inner volume is enclosed by a top housing surface 1111 (e.g., a ceiling), a bottom housing surface 1113 (e.g., a floor), side housing surfaces 1115, 1117 (e.g., front and back walls or width walls), and side housing surfaces 1119, 1123 (e.g., side walls or length walls). The module 200 may be configured so that all side housing surfaces have the same length. However, as illustrated, the module 200 is longer than it is wide.

The first and second sets 402, 404 of power cells 300, each of one or more groups, are separated by the cooling fluid exchange 1000. The first set 402 of power cells 300 reside in a first side (e.g., a leftward side) of the inner volume, and the second set 404 of power cells 300 reside in a second side (e.g., a rightward side) of the inner volume.

The top housing surface 1111 and bottom housing surface 1113 of the housing 1100 are in contact with the top side 213 and bottom side 212 of the cooling fluid exchange 1000. Accordingly, the top and bottom sides 1111 and 1113 of the housing 1113 and the top and bottoms of the power cells 300 are separated by the distance D. This separation distance D forms gaps for respective flow spaces that allows for the flow of cooling fluid over the tops and bottoms of the power cells 300, as will be described in more detail below.

In FIGS. 4A and 4B, the power cells 300 are arranged in a staggered “fork” manner of FIG. 3, with a stack width of six cells 300. The stack width of the cells can be more than six, or less than six, depending on the application and size of the housing 1100. Other stack arrangements can also be used, such as a non-staggered arrangement in which central axes of the cylinders form the vertices of a square matrix.

The cooling fluid exchange 1000 can be arranged as a manifold that directs cooling fluid to and from the power cells 300 to cool the power cells 300, as indicated by the flow arrows 1090, 1091, 1092 and 1093 in FIG. 4B and as will be described in more detail below. The cooling fluid can be a dielectric fluid (e.g., a dielectric liquid) that cools the cells 300 by direct immersion cooling. In the example embodiment of FIGS. 4A and 4B, the cooling fluid exchange 1000 extends through the center of the housing 1100 to separate the power cells 300 into the first set 402 and the second set 404, as described with reference to FIG. 4A.

As further described in reference to FIGS. 4B and 4C, the cooling fluid exchange 1000 has one or more supply conduit structures and one or more return conduit structures. A supply conduit structure is used to provide chilled or cooled fluid to the housing 1100, and a return conduit structure is used to remove warmed fluid from the housing 1100.

Each supply conduit structure includes a supply ingress and a supply egress. Chilled cooling fluid from a chiller enters the supply conduit structure through the supply ingress, and exits the supply conduit structure through the supply egress. When exiting the supply conduit structure through the supply egress, the cooling fluid enters the volume of the housing 1100 to cool the power cells.

Conversely, the return conduit structure includes a return ingress and a return egress. Warmed cooling fluid exits the volume of the housing 1100 through the return ingress and enters the return conduit structure. The warmed cooling fluid then exits the return conduit structure through the return egress, and is then routed to the chiller for cooling.

Which particular conduit structure functions as a supply conduit structure and which functions as a return conduit structure depends on the direction of cooling fluid flow. For the flow arrows 1090, 1091, 1092 and 1093 of FIG. 4B, the conduit structures 1030 and 1050 are supply conduit structures, and the conduit structure 1010 is a return conduit structure. Were the cooling fluid flow reversed, then the conduit structures 1030 and 1050 would be return conduit structures, and the conduit structure 1010 would be the supply conduit structure.

As shown in FIG. 4C, which is a perspective view of the cooling fluid exchange 1000, a first supply conduit structure 1030 and a second supply conduit structure 1050 are similar to a first return conduit structure 1010 in that they are configured as elongated ducts that direct cooling fluid along their lengths. The first supply conduit structure 1030, the second supply conduit structure 1050, and the first return conduit structure 1010 are isolated from each other within the cooling fluid exchange 1000.

FIGS. 4D and 4E provide additional detail of the cooling fluid exchange 1000. In particular, FIG. 4D is a first side view of the cooling fluid exchange 1000, and FIG. 4E is a second side view of the cooling fluid exchange 1000, showing a side opposite to the first side.

Referring to FIGS. 4C, 4D and 4E, the cooling fluid exchange 1000 has a first return conduit structure 1010 that extends along a first longitudinal axis 1021, a first supply conduit structure 1030 that extends along a second longitudinal axis 1031, and a second supply conduit structure 1050 that extends along a third longitudinal axis 1051. The second and third longitudinal axes 1031, 1051 are parallel to the first longitudinal axis 1021.

The first supply conduit structure 1030 is an upper supply conduit structure and the second supply conduit structure 1050 is a lower supply conduit structure. The first return conduit structure 1010 is interposed between the first supply conduit structure 1030 and the second supply conduit structure 1050. In this example embodiment, the three conduit structures 1010, 1030, are 1050 are shaped as rectangular, elongated ducts that direct fluid in and out of the cooling fluid exchange 1000. Other duct cross sections can also be used, for example, cross sections with curved rather than angled interiors.

The first return conduit structure 1010 receives the heated cooling fluid from the inner volume of the housing 1100. The first return conduit structure 1010 has a first return end portion 1012 and a second return end portion 1014 opposite end of the structure from the first return end portion 1012. The first return conduit structure 1010 has two return ingresses, with one return ingress on each side of the conduit structure. For example, as shown in FIG. 4C, the first return conduit structure 1010 includes a first return ingress 1018 of one or more openings 1018 (e.g., one or more elongated slots) on a first side, and, as shown in FIG. 4E, a second return ingress 1019 of one or more openings 1019 on a second side opposite the first side. Both the first return ingress 1018 and second return ingress 1019 extend between the first return end portion 1012 and the second return end portion 1014. In some embodiments, the first return ingress 1018 and second return ingress 1019 extend the length of the power cells 300 being cooled.

The opening 1018 in the first side of the first return conduit structure 1010 is, in this example embodiment, a single elongated opening 1018 or slot that is along the first longitudinal axis 1021. The opening 1019 in the first return conduit structure 1010 on the second side is also a single elongated opening 1019 or slot that is along and parallel to the first longitudinal axis 1021. Other opening geometries can also be used, and are described below.

The first return conduit structure 1010 also has a first return egress 1020 of one or more openings 1020 at the first return end portion 1012. The return cooling fluid is exhausted from return conduit structure 1010 through the first return egress 1020. In FIG. 4D, the return egress 1020 is on the first side of the first return conduit structure 1010. However, instead of the port on the side as the return egress 1020 as shown in FIG. 4D, the return egress 1020 can be on the distal side edge of the of the cooling fluid exchange 1000 that is situated away from the central points of the axes 1021, 1031 and 1052, e.g., as illustrated for return egress 3020 in FIG. 4G. Both options are depicted in FIG. 4C.

As shown in FIGS. 4C and 4D, the first supply conduit structure 1030 and second supply conduit structure 1050 are similar to the first return conduit structure 1010 in that they are configured as elongated ducts that direct cooling fluid along their lengths. The first supply conduit structure 1030 and second supply conduit structure 1050 are fluidly separated or isolated from the first return conduit structure 1010 and each other.

The first supply conduit structure 1030 has a first supply end portion 1032 and a second supply end portion 1034 opposite the first supply end portion. The first supply conduit structure 1030 has two supply egresses, with one supply egress on each side. For example, as shown in FIG. 4D, the first supply conduit structure 1030 has a first supply egress 1038 of one or more openings 1038 (e.g., one or more elongated slots) on a first side, and, as shown in FIG. 4E, a second supply egress 1039 of one or more openings 1039 on a second side opposite the first side. Both the first supply egress 1038 and second supply egress 1039 extend between the first supply end portion 1032 and the second supply end portion 1034.

The first supply conduit structure 1030 also has first supply ingress 1040 of one or more openings 1040 at the first supply end portion 1032. The first supply conduit structure 1030 receives the supply cooling fluid through the first supply ingress 1040. The first supply conduit structure 1030 then directs the supply cooling fluid out of the first supply conduit structure 1030 through the first supply egress 1038 and second supply egress 1039 to enter the volume of the housing 1100 to cool the power cells.

The second supply conduit structure 1050 has a first supply end portion 1052 and a second supply end portion 1054 opposite the first supply end portion 1052. The second supply conduit structure 1050 has two supply egresses, with one supply egress on each side. For example, as shown in FIG. 4D, the second supply conduit structure 1050 has a first supply egress 1058 of one or more openings 1058 (e.g., one or more elongated slots) on a first side, and, as shown in FIG. 4E, a second supply egress 1059 of one or more openings 1059 on a second side opposite the first side. Both the first supply egress 1058 and second supply egress 1059 extend between the first supply end portion 1052 and the second supply end portion 1054.

The second supply conduit structure 1050 also has a second supply ingress 1060 of one or more openings 1060 at the first supply end portion 1052. The second supply conduit structure 1050 receives the supply cooling fluid through the second supply ingress 1060, and then directs the supply cooling fluid out of the second supply conduit structure 1050 through the second supply egress 1058 and second supply egress 1059 to enter the volume of the housing 1100 to cool the power cells.

As illustrated in FIGS. 4D and 4E, the supply ingresses 1040 and 1060 are on a common side of the cooling fluid exchange. However, instead of the ports being positioned as shown in FIG. 4D, the supply ingresses 1040 and 1060 can instead be on the distal side edge of the of the cooling fluid exchange 1000 that is situated away from the central points of the axes 1021, 1031 and 1052, e.g., as illustrated for supply ingresses 3040 and 3060 in FIG. 4G. Both options are depicted in FIG. 4C.

Similar to the first return conduit structure 1010, the openings 1038 and 1039 in the first supply conduit structure 1030 are respective single elongated slots 1038 and 1039 that are along and parallel to the second longitudinal axis 1031. Similarly, the openings 1058 and 1059 in the second supply conduit structure 1050 are respective single elongated slots 1058 and 1059 that are along and parallel to the third longitudinal axis 1051. In some embodiments, the supply egresses 1038, 1039, 1058, and 1059 extend the length of the power cells 300 being cooled.

In some implementations, the first return conduit structure 1010, the first supply conduit structure 1030, and the second supply conduit structure 1050 are aligned so that the cooling fluid exchange 1000 has a rectangular cross section. For example, the first side of the first return conduit structure 1010, the first side of the first supply conduit structure 1030, and the first side of the second supply conduit structure 1050 face a common side and reside on a common plane so that they are flush with one another. Such an arrangement is not necessary, however, and the cooling fluid exchange 1000 need not have a rectangular cross section, and/or may have conduits that are not rectangular in shape.

The cross sectional areas of the conduit structures can be selected to accommodate fluid flow rates and velocities. If it is desired that the fluid velocity be the same in all conduit structures, then the total cross-sectional area of the conduit structures that are serving as supply conduit structures should be approximately the same as the total cross-sectional area of the conduit structures serving as return conduit structures. The fluid velocities need not be the same in each conduit structure, however.

In operation, the cooling fluid exchange 1000, housing 1100 and power cells 300 are operatively associated to direct the cooling fluid along the flow path depicted by the arrows in FIG. 4B. In particular, flow paths 1090, 1091, 1092 and 1093 are formed through the gaps near the top and bottoms of the power cells 300 and the top and bottom sides 1111 and 1113 of the housing 1100, and through the central portions of the power cells 300. The direction of the flow paths 1090, 1091, 1092 and 1093 shown are for supply conduits 1030 and 1050, and a return conduit 1010. As described above, reversal of the direction of the flow paths 1090, 1091, 1092 and 1093 occurs when the conduit 1010 is the supply conduit and the conduits 1030 and 1050 are the return conduits.

Thus, in the embodiment shown, the cooling fluid flow is generally in a first direction at the top and bottom ends of the power cell 300, and in an opposite direction at the middle portions of the bodies of the power cells 300 (the mid-sections of the power cells 300). However, for embodiments with only one supply conduit structure and one return conduit structure in the cooling fluid exchange, the fluid flow may be in a first general direction along a top portion of the power cell, and in a second general direction along the bottom portion of the power cell and that is opposite the first general direction.

The cooling fluid exits the supply egresses of the cooling fluid exchange 1000 in an outward direction, e.g., normal with respect to the length of the cooling fluid exchange 1000. With reference to FIGS. 3 and 4A, the bus bars 302, the braces 202 and 204 and power cell 300 ends can provide a physical barrier to help direct the cooling fluid to the end sides 1019 and 1023 of the housing 1100 along the top and bottom gaps formed between the braces 202 and 204 and the top and bottom surfaces 1111 and 1113 of the housing 1100, preventing the cooling fluid from flowing back to the cooling fluid exchange 1000 prematurely. In an example embodiment, the braces 202 and 204 and the supply egresses are positioned so that fluid entering the housing 1100 flows above the braces 204 and below the braces 202, within the gaps of the distance D.

The physical barrier provided by the bus bars 302, power cells 300 and the braces 202 and 204 need not be completely impervious to fluid flow, and some cooling fluid may circulate back to the return conduit structure 1010 return ingress 1018 before reaching the sides 1019 and 1023 of the housing 1100.

The cooling fluid flows along the respective flow paths 1090, 1091, 1092 and 1093 to form cooling fluid loops that extend from the supply conduit to the side housing surfaces 1119 and 1123 and return to the return conduit through the spaces between the bodies of the power cells 300. These flow paths result in immersion cooling of the power cells 300, where each flow path spans the number of power cells 300, e.g., six power cells 300 in FIGS. 4A and 4B, arranged along the width of the housing 1100.

FIG. 4F is a first side view of another example embodiment of a cooling fluid exchange 2000. The cooling fluid exchange 2000 is similar to the cooling fluid exchange 1000 in FIGS. 4B-4E, with the exception of its supply egresses and return ingresses being shaped as groups of slots. Such an embodiment may be used, for example, to increase structural strength of the cooling fluid exchange 1000. For example, similar to the cooling fluid exchange 1000, the cooling fluid exchange 2000 has a first supply conduit structure 2030, a second supply conduit structure 2050, and a return conduit structure 2010 residing in between. The first return conduit structure 2010 has two return ingresses, with one return ingress 2018 on each side. Each return ingress 2018 is made of multiple openings 2018 (e.g., multiple elongated slots) on each side. Similarly, the openings 2058 in the first supply conduit structure 2030 and second supply conduit structure 2050 are made of multiple openings or slots 2038, 2058, respectively. The cooling fluid exchange 2000 has a return egress 2020 that allows the cooling fluid to exit the cooling fluid exchange 2000, and two supply ingresses 2040, 2060 that receive the cooling fluid.

FIG. 4G is a first side view of yet another example embodiment of a cooling fluid exchange 3000. The cooling fluid exchange 3000 is similar to the cooling fluid exchange 1000 in FIGS. 4B-4E, with the exception of its return egress 3020 and supply ingresses 3040, 3060 being at the end surface 3010 of the cooling fluid exchange 3000. For example, instead of the return egress 3020 and supply ingresses 3040, 3060 being on the first and second surfaces of the cooling fluid exchange 3000, the return egress 3020 and supply ingresses 3040, 3060 are disposed on the end surface of the cooling fluid exchange 3000. Elongated slots 3018, 3038 and 3058 provide similar functionality as the slots 1018, 1038 and 1058, except that the slots are realized by a series of small holes or perforations instead of a single, long opening.

FIG. 4H is a first side view of yet another example embodiment of the cooling fluid exchange 4000. The cooling fluid exchange 4000 has a first supply conduit structure 4030, a second supply conduit structure 4050, and a return conduit structure 4010 residing in between. The conduit structures 4010, 4030 and 4050 have a tubular shape, with the return conduit structure 4010 having an inner diameter larger than the inner diameters of the supply conduit structures 4030, 4050. The conduit structures 4010, 4030 and 4050 are attached to and spaced by flanges or plates 4010. The first return conduit structure 4010 has two return ingresses, with one return ingress 4018 on each side. Similarly, the supply conduit structures 4030, 4050 have supply egresses 4038, 4058 made of openings or slots 4038, 4058 through which the cooling fluid flows to the power cells.

FIG. 4I is a cross section view of the cooling fluid exchange 1000 illustrated in FIGS. 4B-4E. The cooling fluid exchange 1000 provides central, structural support in the battery assembly housing 1100. For example, the cooling fluid exchange 1000 is interposed between and contacts the top housing surface 1111 and the bottom housing surface 1113 such that the first and second sides of the first return conduit structure 1010, the first and second sides of the first supply conduit structure 1030, and the first and second sides of the second supply conduit structure 1050 are normal to the top housing surface 1111 and bottom housing surface 1113. The cooling fluid exchange 1000 optionally bears load between the top housing surface 1111 and the bottom housing surface 1113 to provide structural support along a short axis 1061 of the cooling fluid exchange 1000. Referring also to FIG. 4B, the cooling fluid exchange 1000 is also interposed between the front wall 1115 and the back wall 1117 such that the first and second sides of the first return conduit structure 1010, the first and second sides of the first supply conduit structure 1030, and the first and second sides of the second supply conduit structure 1050 are substantially normal to the front wall 1115 and the back wall 1117. The cooling fluid exchange 1000 can also optionally bear load between the front wall 1115 and the back wall 1117 to provide structural support.

In some embodiments, the long axis 1070 of each power cell 300 (which is longer than it respective axes in other dimensions) is perpendicular to the general direction of at least a portion of each flow path 1090, 1091, 1092 and 1093. For example, along length of the axis 1070 between the braces 202 and 204, the fluid flows across the body of the power cells in a direction from the outer side walls of the battery module 200 toward the return ingress.

Again, in the embodiment shown, the cooling fluid flow is generally in a first direction at the top and bottom ends of the power cell 300, and in an opposite direction at the middle portions of the bodies of the power cells 300. However, for embodiments with only one supply conduit structure and one return conduit structure in the cooling fluid exchange, where the supply conduit structure is positioned near a top of the power cells, and the return conduit structure is positioned near the bottom of the power cells (or vice-versa), the fluid flow may be in a first general direction along a top portion of the power cell, and in a second general direction along the bottom portion of the power cell and that is opposite the first general direction.

While the example embodiments above are illustrated with a total of three conduits, e.g., two supply conduits and one return conduit, or two return conduits and one supply conduit, other embodiments may include only one supply and one return conduit, and yet other embodiments may include multiple return conduits and multiple supply conduits. Accordingly, the flows described above may likewise differ, based on the number of conduits used.

FIG. 4J is a perspective view of cooling fluid flow within the battery assembly 1001. The cooling fluid is forced by a coolant pumping apparatus 1080 (e.g., a pump and condenser assembly) that flows supply coolant 1082 into the first supply ingress 1040 and second supply ingress 1060, and receives return coolant 1084 from the return egress 1020 to form a closed loop cooling system (e.g., a closed loop refrigeration cycle). A first portion of the supply coolant 1082 flows through the first supply egress 1040 and a second portion of the coolant 1082 flows through the second supply ingress 1060 to supply cooling to the power cells. The cooling fluid exchange 1000, the housing 1100 and power cells 300 as configured form two cooling fluid loops on each side, with one upper loop meeting a lower loop in the middle of the power cells 300, where the heated coolant returns to the return structure 1010 of the cooling fluid exchange 1000 to flow back to the pumping apparatus 1080. For example, upper path 1090 meets lower path 1091 in the middle of the power cells 300 on the right side of the cooling fluid exchange 1000, and the upper path 1092 meets lower path 1093 in the middle of the power cells 300 on the left side of the cooling fluid exchange 1000.

FIG. 4K is a cross section view of the cooling fluid exchange 5050 configured to provide cooling on only one side of a battery module 5000. The cooling fluid exchange 5050 is similar to the exchange 1000 of FIG. 4C, but has openings only on one side of the cooling fluid exchange 5050. These openings face the power cells 300 to form a cooling fluid loop on one side of the cooling fluid exchange 5050, cooling the power cells 300 on that one side.

FIG. 4L is a side view of another embodiment of a cooling fluid exchange 5200. The cooling fluid exchange 5200 is similar in construction to the cooling fluid exchange 1100 of FIGS. 4C-4E, except that the first supply conduit structure 1030 has first supply ingress 5240 of one or more openings 5240 located between the end portions 1032 and 1034. The second supply ingress 5260 and the return ingress 5220 are likewise positioned within the conduit structures 1010 and 1050. More generally, supply ingresses and return egresses may be positioned at any location within the end portions or between the end portions.

While embodiments of the cooling fluid exchange have been shown as a generally straight, symmetric structure, embodiments can be curved, asymmetric, or even angled to accommodate various battery module geometries. Additionally, the cooling fluid exchange can be made of a strong material such as metal (e.g., aluminum or steel) or high-strength, heat resistant polymer.

The method that is realized by the example embodiments above allows for controlled cooling fluid flow over the sides of the power cells and through the power cells in a controlled fluid loop. More particularly, for multiple power cells that each have a body disposed along a respective longitudinal axis, and that each have first end at a first point on the longitudinal axis and a second end at a second point on the longitudinal axis, the power cells are arranged within a housing adjacent to each other. In particular, the power cells are arranged adjacent to each other so the respective first ends face a common first side and the respective second ends face a common second side.

The power cells are then immersed in a cooling fluid within the housing so the power cells are thermally coupled to the cooling fluid. Thereafter, a fluid flow of the cooling fluid is generated around the power cells within the housing. In one example embodiment, the cooling fluid is provided into the housing thorough a first supply egress that spans a length of the power cells within the housing and that is longitudinally perpendicular to the longitudinal axes of the power cells. The cooling fluid is removed from the housing thorough a first return ingress that spans the length of the power cells within the house and that is longitudinally perpendicular to the longitudinal axes of the power cells. Cooling fluid can also be provided into the housing thorough a second supply egress that spans the length of the power cells within the housing and that is longitudinally perpendicular to the longitudinal axes of the power cells, and wherein the first return ingress is between the first supply egress and the second supply egress. For example, in FIG. 4C, slots 1038 and 1058 may be the first and second supply egress, and slot 1018 may be the return ingress. The first supply egress 1038 is disposed along the common first side, and the second supply egress 1058 is disposed along common second side.

In an alternative embodiment, the cooling fluid is provided into the housing thorough a first supply egress that spans a length of the power cells within the housing and that is longitudinally perpendicular to the longitudinal axes of the power cells. The cooling fluid is removed from the housing thorough a first return ingress that spans the length of the power cells within the house and that is longitudinally perpendicular to the longitudinal axes of the power cells. Cooling fluid can also be removed from the housing thorough a second return ingress that spans the length of the power cells within the housing and that is longitudinally perpendicular to the longitudinal axes of the power cells, and wherein the first supply egress is between the first return ingress and the second return ingress. For example, in FIG. 4C, slots 1038 and 1058 may be the first and second return ingresses, and slot 1018 may be the supply egress. The first return ingress 1038 is disposed along the common first side, and the second return ingress 1058 is disposed along common second side.

In yet another embodiment, the power cells may be arranged in a sideways manner instead of upright, as shown in FIG. 4M, which is a cross section view of another embodiment of the battery module 211 with an alternative power cell arrangement. In FIG. 4M, the power cells are arranged end-to-end in pairs, e.g., pair 301-1 and 301-2, pair 301-3 and 301-4, and so on. Here, the cooling fluid flows 1094, 1095, 1096 and 1097 traverse the power cells in paths that are mostly parallel to the longer sides of the power cells, i.e., the longitudinal axes, of the power cells.

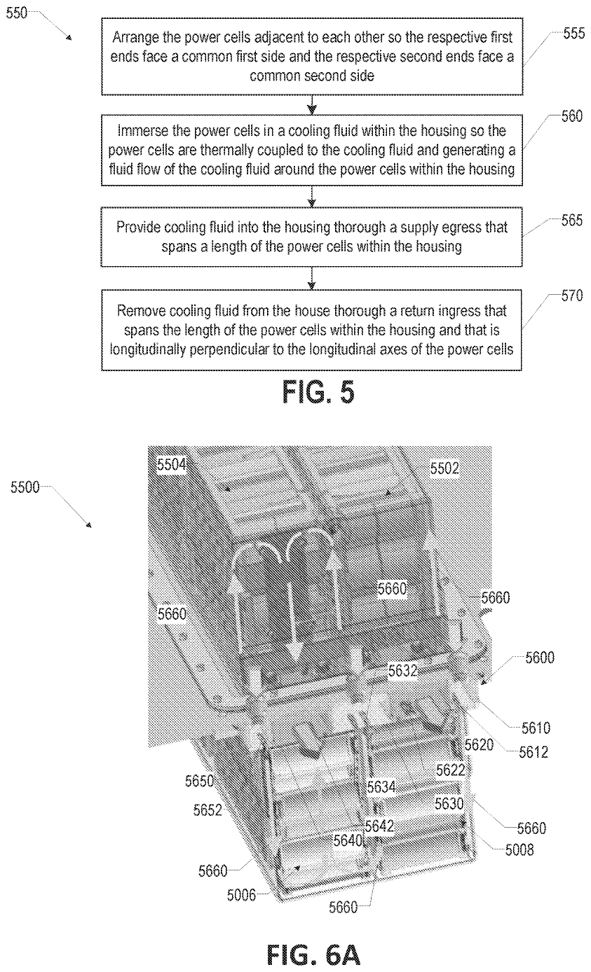

FIG. 5 is a flow diagram of a method (550) of cooling power cells. The method includes, for multiple of power cells, each power cell having a body disposed along a respective longitudinal axis and having a first end at a first point on the longitudinal axis and a second end at a second point on the longitudinal axis: arranging, within a housing, the power cells adjacent to each other so the respective first ends face a common first side and the respective second ends face a common second side (555).

The method also includes immersing the power cells in a cooling fluid within the housing so the power cells are thermally coupled to the cooling fluid, and also includes generating a fluid flow of the cooling fluid around the power cells within the housing (560).

The method also includes providing cooling fluid into the housing thorough a first supply egress that spans a length of the power cells within the housing (565). In some embodiments, providing cooling fluid into the housing thorough the first supply egress that spans a length of the power cells within the housing can includes providing cooling fluid into the housing thorough a first supply egress that spans the length of the power cells within the housing and that is longitudinally perpendicular to the longitudinal axes of the power cells.

The method also includes removing cooling fluid from the housing thorough a first return ingress that spans the length of the power cells within the house and that is longitudinally perpendicular to the longitudinal axes of the power cells (570).

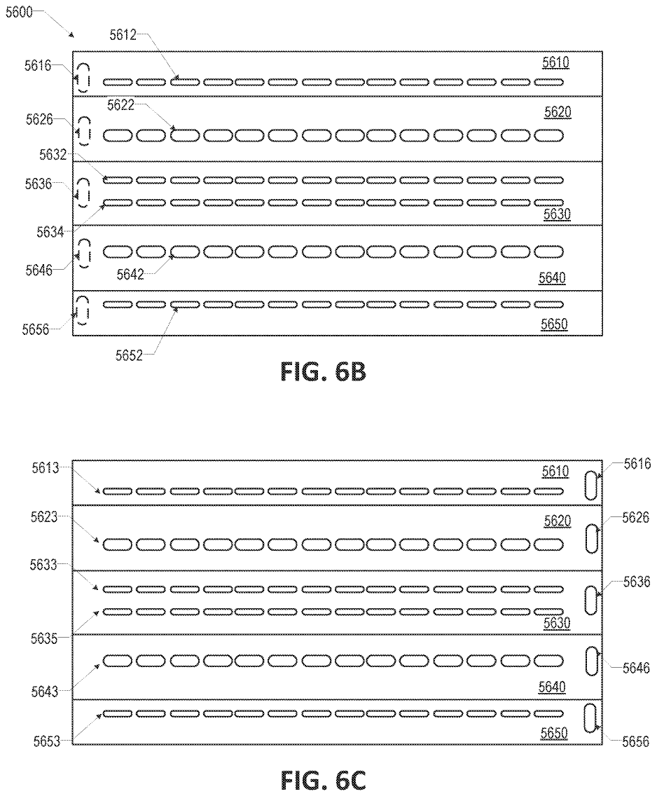

The cooling fluid exchange embodiments described thus far provide cooling for single stacks of power cells on one or both sides of the cooling fluid exchange. However, the cooling fluid exchange can also provide cooling for multiple stacks of power cells on either side. One example embodiment is illustrated in FIGS. 6A-6C. In particular FIG. 6A is a cross-section view of anther embodiment of the battery module 5500, FIG. 6B is first side view of a cooling fluid exchange used in the battery module 5500 of FIG. 6A, and FIG. 6C is second side view of a cooling fluid exchange used in the battery module 5500 of FIG. 6A. The battery module 5500 may be used, for example, in a hybrid electric vehicle (HEV), or in other mobile or stationary applications.

The battery module 5500 includes four stacks of power cells 5502, 5504, 5506 and 5508. The power cells in each stack 5502, 5504, 5506 and 5508 may be secured by braces similar to the braces 202 and 204 of FIG. 4A, and interconnected by bus bars, such as described with reference to FIG. 3. The battery module includes a cooling fluid exchange 5500 that includes five conduit structures 5610, 5620, 5630, 5640 and 5650. Given the flow illustrated in FIG. 6A by flow arrow 5660, conduit structures 5610, 5630 and 5650 function as supply conduit structures, and conduit structures 5620 and 5640 function as return conduit structures.

The supply conduit structures 5610, 5630 and 5650 include supply ingresses 5612, 5632, 5634, and 5652, and the return conduit structures 5620 and 5640 include return egresses 5622 and 5642. Corresponding return egresses 5623 and 5643 and supply egresses 5613, 5633, 5635, and 5653 are on the opposite side of the cooling fluid exchange, as shown in FIG. 6C.

The cooling fluid exchange 5500 includes supply conduit ingresses and return conduit egresses. For example, the supply conduit ingresses 5616, 5636 and 5656, and return conduit egresses 5626 and 5646 can be ports on a side of the exchange 5500, as shown in FIGS. 6A and 6B. In other embodiments, the supply conduit ingresses and return conduit egresses can be openings on the distal end of the cooling fluid exchange 5500, similar to the opening described with reference to FIG. 4G.

Other features and aspects described with reference to FIGS. 4A-5 can also be applied to FIGS. 6A-6C.

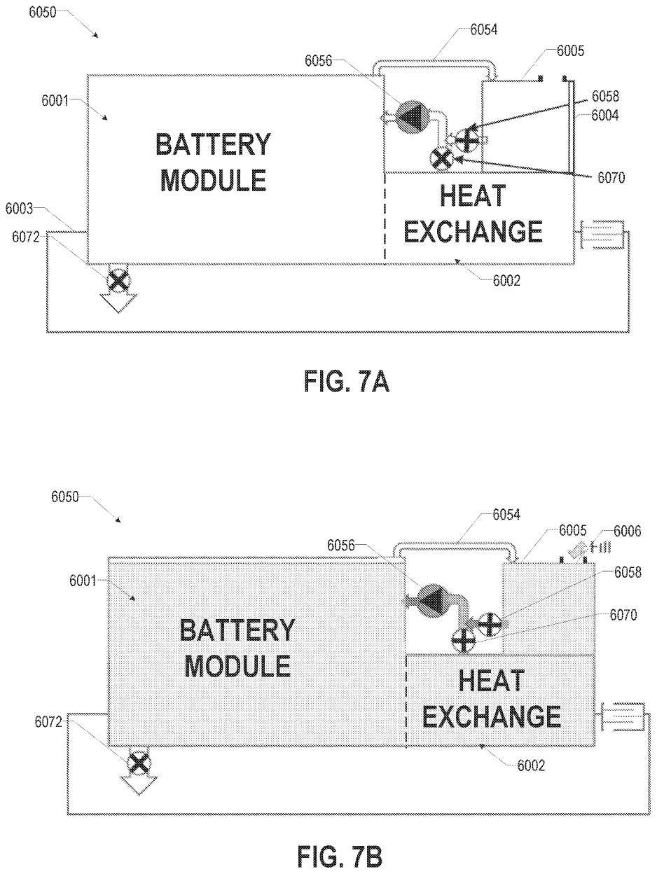

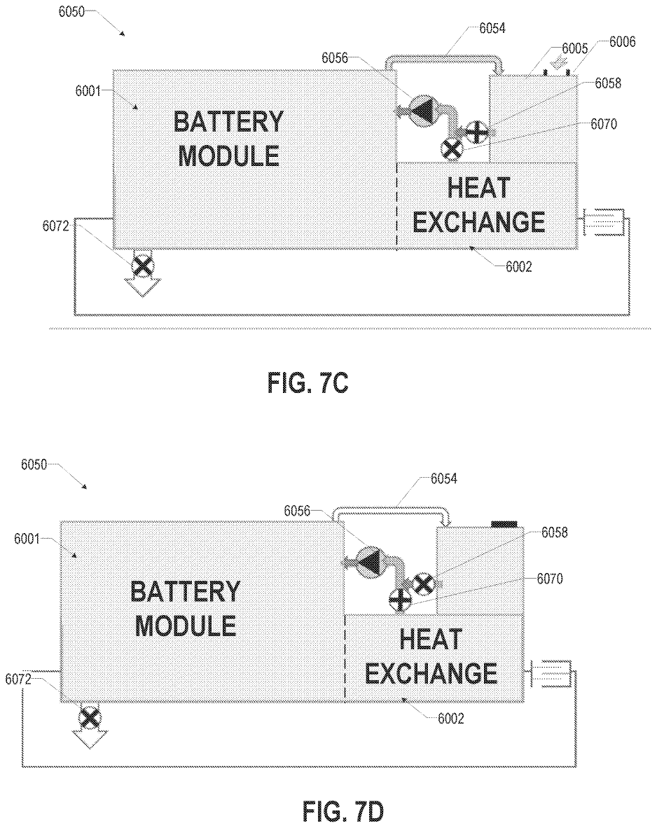

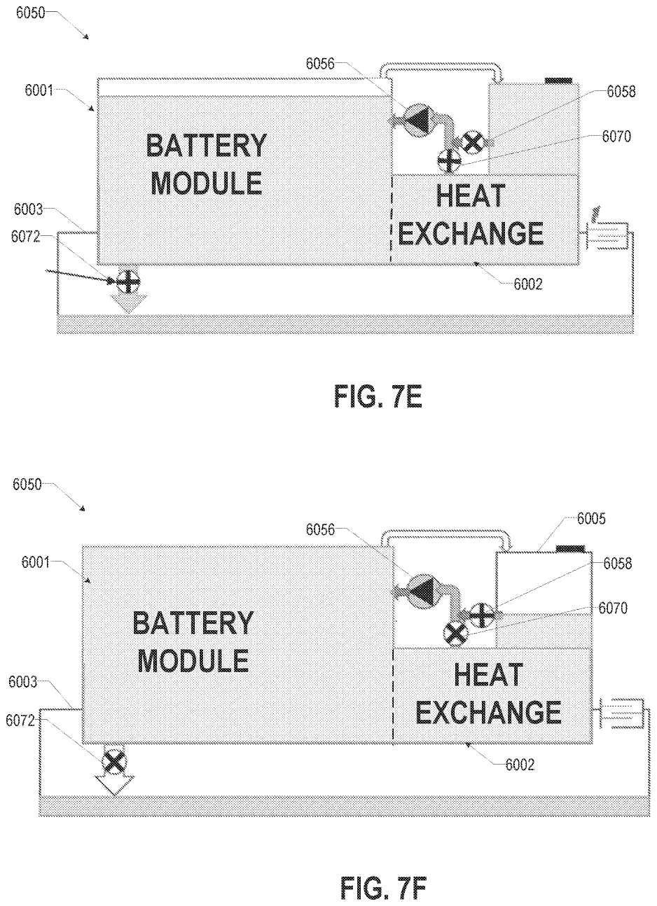

FIGS. 7A-7F are illustrations of various stages of coolant fluid levels in a battery assembly 6050 during filling and venting events. The battery assembly 6050 is designed to reduce or prevent thermal propagation during a thermal runaway event. In a thermal runaway event, a single cell can vent high-temperature gas. The vented gas can overheat neighboring power cells, which in turn fail and release energy that heats more cells, causing a cascade effect of thermal propagation. The thermal battery assembly 6050 features a closed cooling system with fluid fill point, pump, cooler, filter, pressure relief valve, vent exit, and catch volume. The battery assembly 6050 features a dielectric fluid circuit with an electronic unit (e.g., a DC-DC converter) that uses a dielectric cooling fluid that cools both the vented gas and surrounding cells to stop or reduce thermal propagation. During a thermal runaway event, vent gas and fluid are expelled from the battery module to the catch volume. The piping system of the battery assembly 6050 can be arranged to cause the dielectric fluid in the electronic unit to flow to the battery module under gravity to cool the cells and prevent thermal propagation. Alternatively, the pump and pair of valves are used to transfer fluid from the electronic unit to the battery module.

The battery assembly 6050 has one or more battery modules 6001 (such as any of the battery modules described above), a heat exchange 6002, a catch can 6003, and an electronic unit 6004 that manages filling and refilling of the battery module and cooling system, and a refill tank 6005 (e.g., a coolant reservoir). The battery assembly 6050 also includes a coolant pumping apparatus 6056 (e.g., a pump and condenser assembly), a vent valve 6058, a master valve 6070, a pressure release valve (PRV) 6072, and a fluid conduit 6054 connecting the battery modules 6001 to the refill tank 6005. The vent valve 6058 is fluidly coupled to the refill tank 6005, and the main valve 6070 is fluidly coupled to the return conduit of the battery modules 6001. The pump flows the cooling fluid from the return conduit or the refill tank 6005 (or both) to the supply conduit of the battery modules 6001.

FIG. 7A shows the battery assembly 6050 dry and in a failsafe state. As shown, before the initial fill, the main valve 6070 and PRV 6072 are closed and the vent valve 6058 is opened to fluidly connect the refill tank 6005 to the supply conduit of the battery modules 6001.

FIG. 7B shows the battery assembly 6050 during the initial fill. During the initial fill, the vent valve 6058 is opened while the PRV 6072 is closed. The refill tank 6005 receives the cooling fluid through a fluid inlet 6006. The coolant pumping apparatus 6056 flows the cooling fluid from the refill tank 6005 to the battery modules 6001. During the initial fill, the main valve 6070 is also opened to allow the cooling fluid to begin to circulate (e.g., begin the cooling cycle) through the battery modules 1001. The coolant pumping apparatus 6056 circulates the coolant by pumping the heated coolant from the main valve 6070, cooling the coolant, and flowing the cooled coolant to the supply conduit of the battery modules 6001.

FIG. 7C shows the battery assembly 6050 during the final fill. During the final fill, the main valve 6070 and PRV 6072 are closed, and the vent valve 6058 remains open. The refill tank 6005 receives the final portion of the cooling fluid through a fluid inlet 6006. The coolant pumping apparatus 6056 flows the cooling fluid from the refill tank 6005 to the battery modules 6001 until the battery modules are full, which happens when the refill tank 6005 receives fluid from the battery modules 6001 through the fluid conduit 6054. After the refill tank receives fluid from the fluid conduit 6054, the fluid inlet 6006 is closed to form a closed loop cooling system, and the coolant pumping apparatus 6056 is turned on.

FIG. 7D shows the battery assembly 6050 during normal operation. During normal operation, the main valve 6070 is opened and the PRV 6072 and vent valve 6058 are closed. The coolant pumping apparatus 6056 circulates the cooling fluid in the battery modules 6001 in a closed loop to cool the battery modules 6001.

FIG. 7E shows the battery assembly 6050 during thermal runaway. During thermal runaway, the main valve 6070 and PRV 6072 are opened and the vent valve 6058 is closed. The battery modules 6001 can eject fluid or other matter (e.g., gas, shrapnel and/or particulates) that can pressurize the housing of the battery modules 6001, causing a portion of the cooling fluid in the battery modules 6001 to be ejected through the PRV 6072 into the catch can 6003. Thus, the PRV 6072 prevents over-pressurization of the battery modules 6001, and the catch can 6003 can prevent the cooling fluid or gas from the battery cells to be released to the ambient environment. Additionally, the coolant pumping apparatus 6056 circulates the cooling fluid through the battery modules to cool the battery modules 6001.

FIG. 7F shows the battery assembly 6050 after thermal runaway. After thermal runaway, the main valve 6070 and PRV 6072 are closed, and the vent valve 6058 is opened. The coolant pumping apparatus 6056 flows the extra cooling fluid from the refill tank 6005 to keep the battery modules 6001 cooled. The catch can 6003 can be safely drained after thermal runaway to return the battery assembly 6050 to normal conditions.

In some implementations, the refill tank 6005 may have sufficient hydraulic head to refill the battery module by gravity feed. When a thermal event occurs, the main valve 6070 may close and the vent valve 6058 will open, and the battery module will refill due to the hydraulic head of the refill tank. In another embodiment, the two valves 6058 and 6070 can be omitted, and flow through the battery module and through the header tank may be controlled by pipe diameter sizing.

Various aspects of the present subject matter are set forth below, in review of, and/or in supplementation to, the embodiments described thus far, with the emphasis here being on the interrelation and interchangeability of the following embodiments. In other words, an emphasis is on the fact that each feature of the embodiments can be combined with each and every other feature unless explicitly stated or taught otherwise.

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 is an apparatus comprising a cooling fluid exchange. The cooling fluid exchange comprises a first return conduit structure extending along a first longitudinal axis and including a first return end portion and a second return end portion opposite the first return end portion, wherein the first return conduit structure further includes: a first return ingress of one or more openings on a first side of the first return conduit structure and between the first return end portion and the second return end portion, and a first return egress of one or more openings; and a first supply conduit structure extending along a second longitudinal axis that is parallel to the first longitudinal axis and including a first supply end portion and a second supply end portion opposite the first supply end portion, wherein the first supply conduit structure further includes: a first supply egress of one or more openings on a first side of the first supply conduit structure and between the first supply end portion and the second supply end portion, a first supply ingress of one or more openings. The first return conduit structure and the first supply conduit structure are aligned so that the first side of the first return conduit structure and the first side of the first supply conduit structure face a common side.

Embodiment 2 is the apparatus of embodiment 1, wherein the first return egress is within the first return end portion and the first supply ingress is within the first supply end portion.

Embodiment 3 is the apparatus of embodiment 1, wherein the first return egress is between the first return end portion and the second return end portion, and the first supply ingress is between the first supply end portion and the second supply end portion.

Embodiment 4 is the apparatus of any of the embodiments of 1 through 3, wherein the first return conduit structure includes a second return ingress of one or more openings on a second side of the first return conduit structure that is opposite the first side of the return conduit structure and between the first return end portion and the second return end portion; and the first supply conduit structure includes a second supply egress of one or more openings on a second side of the first supply conduit structure opposite the first side of the first supply conduit structure and between the first supply end portion and the second supply end portion.

Embodiment 5 is the apparatus of any of the embodiments of 1 through 4, wherein the apparatus further comprises a housing having an inner volume enclosed by a top housing surface, a bottom housing surface, and side housing surfaces. The cooling fluid exchange is interposed between the top housing surface and the bottom housing surface such that the first and second sides of the first return conduit structure and the first and second sides of the first supply conduit structure are normal to the top housing surface and bottom housing surface and the cooling fluid exchange bears load between the top housing surface and the bottom housing surface.

Embodiment 6 is the apparatus of embodiment 5, wherein the apparatus further comprises a first plurality of power cells residing in a first side of the inner volume and arranged in one or more groups of power cells connected in series or parallel or both and adjacent to the first sides of the first return conduit structure and the first supply conduit structure; and a second plurality of power cells residing in a second side of the inner volume and arranged in one or more groups of power cells connected in series or parallel or both and adjacent to the second sides of the first return conduit structure and the first supply conduit structure.

Embodiment 7 is the apparatus of embodiment 6, wherein the apparatus further comprises a coolant pumping apparatus that supplies coolant into the first supply ingress and receives coolant from the return egress to form a cooling fluid loop. The first portion of the coolant in the cooling fluid loop enters the first side of the inner volume of the housing through the first supply egress and exits the first side of the inner volume of the house through the first return ingress; and a second portion of the coolant in the cooling fluid loop enters the second side of the inner volume of the housing through the one or more openings of the second supply egress and exits the second side of the inner volume of the house through the second return ingress.

Embodiment 8 is the apparatus of any of the embodiments of 1 through 7, wherein the first return egress is on the first side of the first return conduit structure; and the first supply ingress is on a second side of the first supply conduit structure that is opposite the first side of the first supply conduit structure.

Embodiment 9 is the apparatus of embodiment 8, wherein the first return ingress in the first return conduit structure and between the first return end portion and the second return end portion is a single elongated opening having a longitudinal axis that is parallel to the first longitudinal axis; and the first supply egress in first supply conduit structure and between the first supply end portion and the second supply end portion is a single elongated opening having a longitudinal axis that is parallel to the second longitudinal axis.

Embodiment 10 is the apparatus of any of the embodiments of 1 through 9, wherein the apparatus further comprises a second supply conduit structure extending along a third longitudinal axis that is parallel to the first longitudinal axis and including a first supply end portion and a second supply end portion opposite the first supply end portion, wherein the second supply conduit structure comprises: a second supply egress of one or more openings on a first side of the second supply conduit structure and between the first supply end portion and the second supply end portion, and a second supply ingress of one or more openings. The first return conduit structure the first supply conduit structure, and the second supply conduit structure are aligned so that the first side of the first return conduit structure, the first side of the first supply conduit structure and the first side of the second supply conduit structure face a common plane, and the first return conduit structure is interposed between the first supply conduit structure and the second supply conduit structure.

Embodiment 11 is a system comprising a housing having an inner volume; a plurality of power cells residing in the inner volume and arranged in one or more groups of power cells connected in series or parallel or both, each power cell having a body and terminating and first and second ends on opposite sides of the body; and a cooling fluid exchange configured to direct cooling fluid to and from the plurality of power cells and residing in the inner volume at a first end of the one or more groups of power cells, the cooling fluid exchange comprising: a supply conduit structure comprising a supply egress of one or more openings through which the cooling fluid flows from the supply conduit structure to the one or more groups of power cells; and a return conduit structure comprising a return ingress of one or more openings through which the cooling fluid flows from the one or more groups of power cells into the return conduit structure; wherein the cooling fluid exchange is configured to direct the cooling fluid to form a cooling fluid loop extending from the supply conduit structure to a second end of the one or more groups of power cells opposite the first end, and back to the return conduit structure, the cooling fluid loop being a supply fluid pathway and a return fluid pathway; and wherein each cell of the one or more groups of power cells is arranged such that its first end and second end are disposed along one of the supply fluid pathway or the return fluid pathway, and its body is disposed along the other one of the supply fluid pathway or the return fluid pathway.

Embodiment 12 is the system of embodiment 11, wherein the inner volume is enclosed by a top housing surface, a bottom housing surface, and side housing surfaces, and the cooling fluid exchange spans a length of the housing across the inner volume.

Embodiment 13 is the system of embodiment 12, wherein In an aspect, the cooling fluid exchange is interposed between the top housing surface and the bottom housing surface such that a height of the cooling fluid exchange is substantially normal to the top housing surface and bottom housing surface and the cooling fluid exchange bears load between the top housing surface and the bottom housing surface.

Embodiment 14 is the system of any of the embodiments 12 and 13, wherein the side housing surfaces comprises two opposed width walls extending along the width of the housing and two opposed length walls extending along the length of the housing, the cooling fluid exchange being interposed between the two opposed width walls such that the length of the cooling fluid exchange is substantially normal to the two opposed width walls and parallel to the two opposed length walls, and the cooling fluid exchange is configured to bear load between the two opposed width walls.

Embodiment 15 is the system of any of the embodiments 11 through 14, wherein a first of the one or more groups of power cells is adjacent a second of the one or more groups of power cells arranged in a fork arrangement.

Embodiment 16 is the system of embodiment 15, wherein the fork arrangement comprises six power cells.

Embodiment 17 is the system of any of the embodiments 11 through 16, wherein the system further comprising a second supply conduit structure comprising a second supply egress, the return conduit interposed between the supply conduit and the second supply conduit, and wherein the supply egress, the return ingress, and the supply egress face a common side of the cooling fluid exchange such that the cooling fluid exchange has a two supply egresses and one return ingress at the common side.

Embodiment 18 is the system of any of the embodiments 11 through 17, wherein the cooling fluid exchange extends between a first group of the one or more groups of power cells and a second group of the one or more groups of power cells opposite the first group, the supply conduit structure comprising a second supply egress opposite the supply egress and through which a portion of the cooling fluid flows from the supply conduit structure to the second group of power cells, the return conduit structure comprising a second return ingress through which the portion of the cooling fluid flows from second group into the return conduit structure.

Embodiment 19 is the system of any of the embodiments 11 through 18, wherein the cooling fluid exchange is configured to direct the cooling fluid to form a plurality of immersion cooling fluid loops, each of the plurality of immersion cooling fluid loops spanning a plurality power cells arranged along a width of the housing.

Embodiment 20 is the system of any of the embodiments 11 through 19, wherein the housing comprises a battery module configured to be part of an electrically powered vehicle.

Embodiment 21 is the system of any of the embodiments 11 through 20, wherein each power cell in the one or more groups of power cells has a long axis that is longer than its respective axes in other dimensions, and the long axis is horizontal to a road surface.

Embodiment 22 is the system of embodiment 21, wherein a flow direction of cooling fluid is perpendicular to the long axes.

Embodiment 23 is the system of any of the embodiments 11 through 22, each power cell in the one or more groups of power cells has long axis that is longer than it respective axes in other dimensions, and the long axis is perpendicular to a road surface.

Embodiment 24 is an apparatus comprising a supply conduit structure comprising a first supply end portion, a second supply end portion opposite the first supply end portion, and a first supply egress residing between the first supply end portion and the second supply end portion, the supply conduit structure configured to receive a cooling fluid at a first supply ingress and direct the cooling fluid out of the supply conduit structure through the first supply egress; and a return conduit structure comprising a first return end portion, a second return end portion opposite the first return end portion, and a first return ingress residing between the first return end portion and the second return end portion, the return conduit structure configured to receive the cooling fluid at a first return ingress and direct the cooling fluid to a first return egress. The first supply egress and the first return ingress face a common side of the apparatus.

Embodiment 25 is an apparatus comprising a housing having an inner volume; plurality of power cells residing in the inner volume; and a cooling fluid exchange configured to direct cooling fluid to and from the plurality of power cells and residing in the inner volume at a first end of the one or more groups of power cells, the cooling fluid exchange comprising: a supply conduit structure comprising a first supply egress, and the supply conduit structure comprising first supply ingress at a first supply end portion, the supply conduit structure configured to receive a cooling fluid at the first supply ingress and direct the cooling fluid out of the supply conduit structure through the first supply egress and to the power cells; and a return conduit structure comprising a first return ingress, and the return conduit structure comprising a first return egress in the return conduit structure at a first return end portion, the return conduit structure configured to receive the cooling fluid at the first return ingress from the power cells and direct the cooling fluid to the first return egress. The cooling fluid exchange, the housing, and the plurality of power cells are operatively associated to direct the cooling fluid to form a plurality of immersion cooling fluid loops extending from the supply conduit structure to a second end of the one or more groups of power cells opposite the first end, and back to the return conduit structure, each cooling fluid loop being a supply fluid pathway and a return fluid pathway normal to a long axis of the power cells.

Embodiment 26 is an apparatus comprising a housing having an inner volume; a plurality of power cells residing in the inner volume and arranged in one or more groups of power cells connected in series or parallel or both; and a cooling fluid exchange configured to direct cooling fluid to and from the plurality of power cells and residing in the inner volume at a first end of the one or more groups of power cells, the cooling fluid exchange comprising: one or more supply conduit structures, each of the one or more supply conduit structures comprising a first supply egress, and the supply conduit structure comprising a first supply ingress at a first supply end portion, the supply conduit structure configured to receive a cooling fluid at the first supply ingress and direct the cooling fluid out of the supply conduit structure through the first supply egress and to the power cells; and one or more supply return conduit structures, each of the one or more return conduit structures comprising a first return ingress, and the return conduit structure comprising a first return egress at a first return end portion, the return conduit structure configured to receive the cooling fluid at the first return ingress from the power cells and direct the cooling fluid to the first return egress. The cooling fluid exchange, the housing, and the plurality of power cells are operatively associated to direct the cooling fluid to form a cooling fluid loop being a supply fluid pathway and a return fluid pathway, with each cell of the one or more groups of power cells arranged such that its ends are disposed along one of the supply fluid pathway or the return fluid pathway, and a mid-section of each power cell is disposed along the other one of the supply fluid pathway or the return fluid pathway.

Embodiment 27 is a method comprising, for a plurality of power cells, each power cell having a body disposed along a respective longitudinal axis and having a first end at a first point on the longitudinal axis and a second end at a second point on the longitudinal axis: arranging, within a housing, the power cells adjacent to each other; immersing the power cells in a cooling fluid within the housing so the power cells are thermally coupled to the cooling fluid; generating a fluid flow of the cooling fluid around the power cells within the housing, comprising: providing cooling fluid into the housing thorough a first supply egress that spans a length of the power cells within the housing, and removing cooling fluid from the housing thorough a first return ingress that spans the length of the power cells within the housing.

Embodiment 28 is the method of embodiment 27, wherein arranging, within a housing, the power cells adjacent to each other comprises arranging the power cells so the respective first ends face a common first side and the respective second ends face a common second side.

Embodiment 29 is the method of embodiments of any of the embodiments 27 and 28, wherein generating the fluid flow of the cooling fluid around the power cells within the housing further comprises: providing cooling fluid into the housing thorough a second supply egress that spans the length of the power cells within the housing and that is substantially longitudinally perpendicular to the longitudinal axes of the power cells, and wherein the first return ingress is between the first supply egress and the second supply egress.

Embodiment 30 is the method of any of embodiments 27 through 29, wherein the first supply egress is disposed along the common first side; and the second supply egress is disposed along the common second side.

Embodiment 31 is the method of any of embodiments 27 through 30, wherein generating the fluid flow of the cooling fluid around the power cells within the housing further comprises: removing cooling fluid from the housing thorough a second return ingress that spans the length of the power cells within the housing and that is longitudinally perpendicular to the longitudinal axes of the power cells, and wherein the first supply egress is between the first return ingress and the second return ingress.

Embodiment 32 is the method of any of embodiments 27 through 31, wherein the first return ingress is disposed along the common first side; and the second return ingress is disposed along common second side.

Embodiment 33 is the method of embodiment 28, wherein providing cooling fluid into the housing thorough a first supply egress that spans a length of the power cells within the housing comprises providing cooling fluid into the housing through a first supply egress that spans a length of the power cells within the housing and that is longitudinally perpendicular to the longitudinal axes of the power cells.

Embodiment 34 is the method of embodiment 28, wherein removing cooling fluid from the housing thorough a first return ingress that spans the length of the power cells within the housing comprises removing cooling fluid from the housing thorough a first return ingress that spans the length of the power cells within the housing and that is longitudinally perpendicular to the longitudinal axes of the power cells.

Embodiment 35 is the method of any of embodiments 27 through 34, wherein providing cooling fluid into the housing thorough a first supply egress that spans a length of the power cells within the housing comprises providing cooling fluid into the housing thorough a first supply egress that spans a length of the power cells within the housing and that is longitudinally perpendicular to the longitudinal axes of the power cells.

Embodiment 36 is a method comprising, for a plurality of power cells, each power cell having a body disposed along a respective longitudinal axis and having a first end at a first point on the longitudinal axis and a second end at a second point on the longitudinal axis: arranging, within a housing, the power cells along their longitudinal axes so that at least a first end of a first power cell is adjacent to a second end of a second power cell in an end-to-end pair; immersing the power cells in a cooling fluid within the housing so the power cells are thermally coupled to the cooling fluid; generating a fluid flow of the cooling fluid around the power cells within the housing, comprising: providing cooling fluid into the housing thorough a first supply egress that spans a length of the power cells within the housing; and removing cooling fluid from the housing thorough a first return ingress that spans the length of the power cells within the housing.

Various aspects of the present subject matter are set forth below, in review of, and/or in supplementation to, the embodiments described thus far, with the emphasis here being on the interrelation and interchangeability of the following embodiments. In other words, an emphasis is on the fact that each feature of the embodiments can be combined with each and every other feature unless explicitly stated otherwise or logically implausible.

Processing circuitry can include one or more processors, microprocessors, controllers, and/or microcontrollers, each of which can be a discrete or stand-alone chip or distributed amongst (and a portion of) a number of different chips. Any type of processing circuitry can be implemented, such as, but not limited to, personal computing architectures (e.g., such as used in desktop PC's, laptops, tablets, etc.), programmable gate array architectures, proprietary architectures, custom architectures, and others. Processing circuitry can include a digital signal processor, which can be implemented in hardware and/or software. Processing circuitry can execute software instructions stored on memory that cause processing circuitry to take a host of different actions and control other components.

Processing circuitry can also perform other software and/or hardware routines. For example, processing circuitry can interface with communication circuitry and perform analog-to-digital conversions, encoding and decoding, other digital signal processing, multimedia functions, conversion of data into a format (e.g., in-phase and quadrature) suitable for provision to communication circuitry, and/or can cause communication circuitry to transmit the data (wired or wirelessly).

Processing circuitry can also be adapted to execute the operating system and any software applications, and perform those other functions not related to the processing of communications transmitted and received.

Computer program instructions for carrying out operations in accordance with the described subject matter may be written in any combination of one or more programming languages, including computer and programming languages. A non-exhaustive list of examples includes hardware description languages (HDLs), SystemC, C, C++, C#, Objective-C, Matlab, Simulink, System Verilog, System VHDL, Handel-C, Python, Java, JavaScript, Ruby, HTML, Smalltalk, Transact-SQL, XML, PHP, Golang (Go), “R” language, and Swift, to name a few.

Memory, storage, and/or computer readable media can be shared by one or more of the various functional units present, or can be distributed amongst two or more of them (e.g., as separate memories present within different chips). Memory can also reside in a separate chip of its own.

To the extent the embodiments disclosed herein include or operate in association with memory, storage, and/or computer readable media, then that memory, storage, and/or computer readable media are non-transitory. Accordingly, to the extent that memory, storage, and/or computer readable media are covered by one or more claims, then that memory, storage, and/or computer readable media is only non-transitory. The terms “non-transitory” and “tangible” as used herein, are intended to describe memory, storage, and/or computer readable media excluding propagating electromagnetic signals, but are not intended to limit the type of memory, storage, and/or computer readable media in terms of the persistency of storage or otherwise. For example, “non-transitory” and/or “tangible” memory, storage, and/or computer readable media encompasses volatile and non-volatile media such as random access media (e.g., RAM, SRAM, DRAM, FRAM, etc.), read-only media (e.g., ROM, PROM, EPROM, EEPROM, flash, etc.) and combinations thereof (e.g., hybrid RAM and ROM, NVRAM, etc.) and variants thereof.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

As used herein and in the appended claims, the singular forms “a,” “an,” and “the” include plural referents unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

1. An apparatus, comprising:
a cooling fluid exchange, comprising:
a first return conduit structure extending along a first longitudinal axis and including a first return end portion and a second return end portion opposite the first return end portion, wherein the first return conduit structure further includes:
a first return ingress of one or more openings on a first side of the first return conduit structure and between the first return end portion and the second return end portion; and
a first return egress of one or more openings; and
a first supply conduit structure extending along a second longitudinal axis that is parallel to the first longitudinal axis and including a first supply end portion and a second supply end portion opposite the first supply end portion, wherein the first supply conduit structure further includes:
a first supply egress of one or more openings on a first side of the first supply conduit structure and between the first supply end portion and the second supply end portion; and
a first supply ingress of one or more openings;
wherein:
the first return conduit structure and the first supply conduit structure are aligned so that the first side of the first return conduit structure and the first side of the first supply conduit structure face a common side.

2. The apparatus of claim 1, wherein:
the first return egress is within the first return end portion; and
the first supply ingress is within the first supply end portion.

3. The apparatus of claim 1, wherein:
the first return egress is between the first return end portion and the second return end portion; and
the first supply ingress is between the first supply end portion and the second supply end portion.

4. The apparatus of claim 1, wherein:
the first return conduit structure includes a second return ingress of one or more openings on a second side of the first return conduit structure that is opposite the first side of the return conduit structure and between the first return end portion and the second return end portion; and
the first supply conduit structure includes a second supply egress of one or more openings on a second side of the first supply conduit structure opposite the first side of the first supply conduit structure and between the first supply end portion and the second supply end portion.

5. The apparatus of claim 4, further comprising:
a housing having an inner volume enclosed by a top housing surface, a bottom housing surface, and side housing surfaces;
wherein:
the cooling fluid exchange is interposed between the top housing surface and the bottom housing surface such that the first and second sides of the first return conduit structure and the first and second sides of the first supply conduit structure are normal to the top housing surface and bottom housing surface and the cooling fluid exchange bears load between the top housing surface and the bottom housing surface.

6. The apparatus of claim 5, further comprising:
a first plurality of power cells residing in a first side of the inner volume and arranged in one or more groups of power cells connected in series or parallel or both and adjacent to the first sides of the first return conduit structure and the first supply conduit structure; and
a second plurality of power cells residing in a second side of the inner volume and arranged in one or more groups of power cells connected in series or parallel or both and adjacent to the second sides of the first return conduit structure and the first supply conduit structure.

7. The apparatus of claim 6, further comprising:
a coolant pumping apparatus that supplies coolant into the first supply ingress and receives coolant from the return egress to form a cooling fluid loop;
wherein:
a first portion of the coolant in the cooling fluid loop enters the first side of the inner volume of the housing through the first supply egress and exits the first side of the inner volume of the house through the first return ingress; and
a second portion of the coolant in the cooling fluid loop enters the second side of the inner volume of the housing through the one or more openings of the second supply egress and exits the second side of the inner volume of the house through the second return ingress.

8. The apparatus of claim 1, wherein:
the first return egress is on the first side of the first return conduit structure; and
the first supply ingress is on a second side of the first supply conduit structure that is opposite the first side of the first supply conduit structure.

9. The apparatus of claim 8, wherein:
the first return ingress in the first return conduit structure and between the first return end portion and the second return end portion is a single elongated opening having a longitudinal axis that is parallel to the first longitudinal axis; and
the first supply egress in first supply conduit structure and between the first supply end portion and the second supply end portion is a single elongated opening having a longitudinal axis that is parallel to the second longitudinal axis.

10. The apparatus of claim 1, further comprising:
a second supply conduit structure extending along a third longitudinal axis that is parallel to the first longitudinal axis and including a first supply end portion and a second supply end portion opposite the first supply end portion, wherein the second supply conduit structure comprises:
a second supply egress of one or more openings on a first side of the second supply conduit structure and between the first supply end portion and the second supply end portion; and
a second supply ingress of one or more openings;
wherein:
the first return conduit structure the first supply conduit structure, and the second supply conduit structure are aligned so that:
the first side of the first return conduit structure, the first side of the first supply conduit structure and the first side of the second supply conduit structure face a common plane; and
the first return conduit structure is interposed between the first supply conduit structure and the second supply conduit structure.

11. A system, comprising:
a housing having an inner volume;
a plurality of power cells residing in the inner volume and arranged in one or more groups of power cells connected in series or parallel or both, each power cell having a body and terminating and first and second ends on opposite sides of the body; and
a cooling fluid exchange configured to direct cooling fluid to and from the plurality of power cells and residing in the inner volume at a first end of the one or more groups of power cells, the cooling fluid exchange comprising:
a supply conduit structure comprising a supply egress of one or more openings through which the cooling fluid flows from the supply conduit structure to the one or more groups of power cells; and
a return conduit structure comprising a return ingress of one or more openings through which the cooling fluid flows from the one or more groups of power cells into the return conduit structure;
wherein the cooling fluid exchange is configured to direct the cooling fluid to form a cooling fluid loop extending from the supply conduit structure to a second end of the one or more groups of power cells opposite the first end, and back to the return conduit structure, the cooling fluid loop being a supply fluid pathway and a return fluid pathway; and
wherein each cell of the one or more groups of power cells is arranged such that its first end and second end are disposed along one of the supply fluid pathway or the return fluid pathway, and its body is disposed along the other one of the supply fluid pathway or the return fluid pathway.

12. The system of claim 11, wherein the inner volume is enclosed by a top housing surface, a bottom housing surface, and side housing surfaces, and the cooling fluid exchange spans a length of the housing across the inner volume.

13. The system of claim 12, wherein the cooling fluid exchange is interposed between the top housing surface and the bottom housing surface such that a height of the cooling fluid exchange is substantially normal to the top housing surface and bottom housing surface and the cooling fluid exchange bears load between the top housing surface and the bottom housing surface.

14. The system of claim 12, wherein the side housing surfaces comprises two opposed width walls extending along the width of the housing and two opposed length walls extending along the length of the housing, the cooling fluid exchange being interposed between the two opposed width walls such that the length of the cooling fluid exchange is substantially normal to the two opposed width walls and parallel to the two opposed length walls, and the cooling fluid exchange is configured to bear load between the two opposed width walls.

15. The system of claim 11, wherein a first of the one or more groups of power cells is adjacent a second of the one or more groups of power cells arranged in a fork arrangement.

16. The system of claim 15, wherein the fork arrangement comprises six power cells.

17. The system of claim 11, further comprising a second supply conduit structure comprising a second supply egress, the return conduit interposed between the supply conduit and the second supply conduit, and wherein the supply egress, the return ingress, and the second supply egress face a common side of the cooling fluid exchange such that the cooling fluid exchange has a two supply egresses and one return ingress on the common side.

18. The system of claim 11, wherein the cooling fluid exchange extends between a first group of the one or more groups of power cells and a second group of the one or more groups of power cells opposite the first group, the supply conduit structure comprising a second supply egress opposite the supply egress and through which a portion of the cooling fluid flows from the supply conduit structure to the second group of power cells, the return conduit structure comprising a second return ingress opposite the return egress and through which the portion of the cooling fluid flows from the second group into the return conduit structure.

19. The system of claim 11, wherein the cooling fluid exchange is configured to direct the cooling fluid to form a plurality of immersion cooling fluid loops, each of the plurality of immersion cooling fluid loops spanning a plurality power cells arranged along a width of the housing.

20. The system of claim 11, wherein the housing comprises a battery module configured to be part of an electrically powered vehicle.

21. The system of claim 19, wherein each power cell in the one or more groups of power cells has a long axis that is longer than its respective axes in other dimensions, and the long axis is horizontal to a road surface.

22. The system of claim 21, wherein a flow direction of cooling fluid is perpendicular to the long axes.

23. The system of claim 20, wherein each power cell in the one or more groups of power cells has long axis that is longer than it respective axes in other dimensions, and the long axis is perpendicular to a road surface.

24. An apparatus, comprising:
a supply conduit structure comprising a first supply end portion, a second supply end portion opposite the first supply end portion, and a first supply egress residing between the first supply end portion and the second supply end portion, the supply conduit structure configured to receive a cooling fluid at a first supply ingress and direct the cooling fluid out of the supply conduit structure through the first supply egress; and
a return conduit structure comprising a first return end portion, a second return end portion opposite the first return end portion, and a first return ingress residing between the first return end portion and the second return end portion, the return conduit structure configured to receive the cooling fluid at a first return ingress and direct the cooling fluid to a first return egress;
wherein the first supply egress and the first return ingress face a common side of the apparatus.

25. An apparatus, comprising:
a housing having an inner volume;
a plurality of power cells residing in the inner volume; and
a cooling fluid exchange configured to direct cooling fluid to and from the plurality of power cells and residing in the inner volume at a first end of the one or more groups of power cells, the cooling fluid exchange comprising:
a supply conduit structure comprising a first supply egress, and the supply conduit structure comprising first supply ingress at a first supply end portion, the supply conduit structure configured to receive a cooling fluid at the first supply ingress and direct the cooling fluid out of the supply conduit structure through the first supply egress and to the power cells; and
a return conduit structure comprising a first return ingress, and the return conduit structure comprising a first return egress in the return conduit structure at a first return end portion, the return conduit structure configured to receive the cooling fluid at the first return ingress from the power cells and direct the cooling fluid to the first return egress;
wherein the cooling fluid exchange, the housing, and the plurality of power cells are operatively associated to direct the cooling fluid to form a plurality of immersion cooling fluid loops extending from the supply conduit structure to a second end of the one or more groups of power cells opposite the first end, and back to the return conduit structure, each cooling fluid loop being a supply fluid pathway and a return fluid pathway normal to a long axis of the power cells.

26. An apparatus, comprising:
a housing having an inner volume;
a plurality of power cells residing in the inner volume and arranged in one or more groups of power cells connected in series or parallel or both; and
a cooling fluid exchange configured to direct cooling fluid to and from the plurality of power cells and residing in the inner volume at a first end of the one or more groups of power cells, the cooling fluid exchange comprising:
one or more supply conduit structures, each of the one or more supply conduit structures comprising a first supply egress, and the supply conduit structure comprising a first supply ingress at a first supply end portion, the supply conduit structure configured to receive a cooling fluid at the first supply ingress and direct the cooling fluid out of the supply conduit structure through the first supply egress and to the power cells; and
one or more supply return conduit structures, each of the one or more return conduit structures comprising a first return ingress, and the return conduit structure comprising a first return egress at a first return end portion, the return conduit structure configured to receive the cooling fluid at the first return ingress from the power cells and direct the cooling fluid to the first return egress;
wherein the cooling fluid exchange, the housing, and the plurality of power cells are operatively associated to direct the cooling fluid to form a cooling fluid loop being a supply fluid pathway and a return fluid pathway, with each cell of the one or more groups of power cells arranged such that its ends are disposed along one of the supply fluid pathway or the return fluid pathway, and a mid-section of each power cell is disposed along the other one of the supply fluid pathway or the return fluid pathway.

27. A method, comprising:
for a plurality of power cells, each power cell having a body disposed along a respective longitudinal axis and having a first end at a first point on the longitudinal axis and a second end at a second point on the longitudinal axis:
arranging, within a housing, the power cells adjacent to each other;
immersing the power cells in a cooling fluid within the housing so the power cells are thermally coupled to the cooling fluid;
generating a fluid flow of the cooling fluid around the power cells within the housing, comprising:
providing cooling fluid into the housing thorough a first supply egress that spans a length of the power cells within the housing; and
removing cooling fluid from the housing thorough a first return ingress that spans the length of the power cells within the housing.

28. The method of claim 27, wherein arranging, within a housing, the power cells adjacent to each other comprises arranging the power cells so the respective first ends face a common first side and the respective second ends face a common second side.

29. The method of claim 28, wherein generating the fluid flow of the cooling fluid around the power cells within the housing further comprises:
providing cooling fluid into the housing thorough a second supply egress that spans the length of the power cells within the housing and that is substantially longitudinally perpendicular to the longitudinal axes of the power cells, and wherein the first return ingress is between the first supply egress and the second supply egress.

30. The method of claim 29, wherein:
the first supply egress is disposed along the common first side; and
the second supply egress is disposed along the common second side.

31. The method of claim 28, wherein generating the fluid flow of the cooling fluid around the power cells within the housing further comprises:
removing cooling fluid from the housing thorough a second return ingress that spans the length of the power cells within the housing and that is longitudinally perpendicular to the longitudinal axes of the power cells, and wherein the first supply egress is between the first return ingress and the second return ingress.

32. The method of claim 31, wherein:
the first return ingress is disposed along the common first side; and
the second return ingress is disposed along common second side.

33. The method of claim 28, wherein providing cooling fluid into the housing thorough a first supply egress that spans a length of the power cells within the housing comprises providing cooling fluid into the housing through a first supply egress that spans a length of the power cells within the housing and that is longitudinally perpendicular to the longitudinal axes of the power cells.

34. The method of claim 28, wherein removing cooling fluid from the housing thorough a first return ingress that spans the length of the power cells within the housing comprises removing cooling fluid from the housing thorough a first return ingress that spans the length of the power cells within the housing and that is longitudinally perpendicular to the longitudinal axes of the power cells.

35. The method of claim 34, wherein providing cooling fluid into the housing thorough a first supply egress that spans a length of the power cells within the housing comprises providing cooling fluid into the housing thorough a first supply egress that spans a length of the power cells within the housing and that is longitudinally perpendicular to the longitudinal axes of the power cells.

36. A method, comprising:
for a plurality of power cells, each power cell having a body disposed along a respective longitudinal axis and having a first end at a first point on the longitudinal axis and a second end at a second point on the longitudinal axis:
arranging, within a housing, the power cells along their longitudinal axes so that at least a first end of a first power cell is adjacent to a second end of a second power cell in an end-to-end pair;
immersing the power cells in a cooling fluid within the housing so the power cells are thermally coupled to the cooling fluid;
generating a fluid flow of the cooling fluid around the power cells within the housing, comprising:
providing cooling fluid into the housing thorough a first supply egress that spans a length of the power cells within the housing; and
removing cooling fluid from the housing thorough a first return ingress that spans the length of the power cells within the housing.
